(19) United States
(12) Patent Application Publication
(10) Pub. No.: US 2015/0035970 A1
(43) Pub. Date: Feb. 5, 2015

(54) SYSTEMS AND METHODS TO DETECT COATING VOIDS

(71) Applicant: APPLIED VISION CORPORATION, Cuyahoga Falls, OH (US)

(72) Inventors: Kris Brumbaugh, Marshallville, OH (US); Bryan Murdoch, Stow, OH (US)

(73) Assignee: APPLIED VISION CORPORATION, Cuyahoga Falls, OH (US)

(21) Appl. No.: 14/306,699

(22) Filed: Jun. 17, 2014

Related U.S. Application Data
(60) Provisional application No. 61/861,766, filed on Aug. 2, 2013.

(51) Int. Cl. G06T 7/00; G01N 21/90

(52) U.S. Cl. CPC G06T 7/001; G01N 21/9054; G01N 21/909
USPC 348/93

(57) ABSTRACT

Systems and methods to identify defects of a surface coating treatment in a beverage can. One or more image suspects are acquired, including at least a portion of a surface treated by a coating. A coating characteristic detection process is performed on the one or more image suspects. At least one coating characteristic is determined based at least in part on the coating characteristic detection process.

This U.S. patent application claims the benefit of and priority to U.S. provisional patent application Ser. No. 61/861,766 filed on Aug. 2, 2013, which is incorporated by reference herein in its entirety.

### TECHNICAL FIELD

Certain embodiments relate to inspection of spray-coated containers. More particularly, some embodiments relate to systems and methods to detect partial or inconsistent spray coating inside a can (e.g., a beverage can or a food can).

### BACKGROUND

The inside surface of some containers are sprayed with one or more coating materials that prevent the metal from directly contacting (and, in instances, chemically reacting with) the container's contents. For example, such techniques are used to isolate beverages or other fluids or foods from the metal of a fluid-containing can. The spray may be applied at different points during container manufacture, but is typically applied after at least one end and outer walls of a container are formed (e.g., in a can, after the base and cylindrical form are drawn, but before the top of the can is necked).

Sprays may be applied from a nozzle or other means, and specific techniques can include rotating the container (e.g., in the pocket of a star wheel). Various “spray machines” that convey, rotate, and otherwise manage containers through a spray process are used in container industries.

The coating material has various visual properties after application. For example, coatings may be an opaque whitish liquid at the time of application which clears after drying. In other embodiments, dyes or colorants may be added to the coating material to provide a particular wet or dried color. Color or other properties vary dependent on the thickness of the coating. In still further embodiments, the coating remains substantially clear at all times, and reflectivity or changes to underlying colors are capable of being imaged. Drying of the coating material can be conducted using an oven. Alternatively, the coating material can be permitted to air-dry.

Flaws in the coating process may result in coating inconsistencies. Coating inconsistencies include “voids,” or areas where no or insufficient coating is applied resulting in contact between the container's contents and the bare container material. Such voids may compromise the container's contents by, for example, spoiling the flavor and/or causing leaks. Defects relating to coating voids are referred to (in particular instances herein) as “partial spray” defects. Partial spray defects can result in the rejection or return of containers provided to fillers (e.g., companies using the containers for products such as Coca-Cola® or Pepsi®), and may interfere with contracts or business relationships.

Various inspection techniques have been attempted to mitigate partial spray defects with limited success. For example, spray nozzles can be monitored to detect clogging. However, this provides no insight as to whether the direction of spray, or adhesion and distribution of material within the container are satisfactory.

Further limitations and disadvantages of conventional, traditional, and proposed approaches will become apparent to one of skill in the art, through comparison of such systems and methods with the present invention as set forth in the remainder of the present application with reference to the drawings.

### BRIEF SUMMARY

In some embodiments, systems and methods to identify defects of a surface coating treatment in a can (e.g., a beverage can or a food can) are provided. Aspects include illuminating at least a portion of a surface treated by a coating, acquiring one or more image suspects including at least the portion of the surface treated by the coating, adjusting the one or more image suspects to align with a template image, and performing a template matching operation on the one or more image suspects using the template image.

One embodiment provides a method to identify characteristics of a surface coating treatment. The method includes acquiring one or more image suspects including at least a portion of a surface treated by a coating. The method also includes performing a coating characteristic detection process on the one or more image suspects, and determining at least one coating characteristic based at least in part on the coating characteristic detection process. The coating characteristic detection process may include one or more of edge-finding, blob-finding, symmetry analysis, pixel counting, segmentation, brightness analysis, or color analysis. The method may further include generating one or more response signals in response to determining at least one coating characteristic. The response signals may be communicated to one or more of a service notification device, a production pausing device, or a container removing device. The at least one coating characteristic may include one or more of a coating void, a coating thickness, an uncoated condition, a lightly coated condition, a heavily coated condition, coating consistency, coating adhesion, and a number of applied coats. The method may further include illuminating at least the portion of the surface treated by the coating to aid in image acquisition.

One embodiment provides a method to identify characteristics of a surface coating treatment. The method includes acquiring one or more image suspects including at least a portion of a surface treated by a coating, and aligning the one or more image suspects with a template image. The method also includes performing a template matching operation on the one or more image suspects using the template image. The method may further include identifying one or more coating characteristics based at least in part on a result of the template matching operation. The one or more coating characteristics may include one or more of a coating void, a coating thickness, an uncoated condition, a lightly coated condition, a heavily coated condition, coating consistency, coating adhesion, and a number of applied coats. The method may further include generating at least one response signal based at least in part on a result of the template matching operation. The response signal may include a service notification signal, a production pause signal, or a remove container signal. The method may further include illuminating at least the portion of the surface treated by the coating to aid in image acquisition.

One embodiment provides a system that detects defects in a sprayed coating applied inside a beverage can. The system includes an illumination component configured to emit and direct light to an inside of the beverage can. The system also includes an image recording component configured to capture and record one or more images of the inside of the beverage can. The system further includes a characteristic component configured to perform a coating characteristic detection process on the one or more recorded images. The system may also include a reception component configured to receive the beverage can in an image capture position. The system may further include a pre-processing component configured to prepare the one or more recorded images for the coating characteristic detection process. The characteristic component may include a void detection component configured to perform a void detection operation on the one or more recorded images. The void detection operation may be configured to identify the presence or absence of voids in the sprayed coating. The system may include a tracking component configured to identify and track individual cans through production, allowing the individual cans to be followed and actioned based at least in part on the presence or absence of voids. The void detection operation may include one or more of edge-finding, blob-finding, symmetry analysis, pixel counting, segmentation, brightness analysis, or color analysis. The system may further include a feedback component configured to generate a feedback signal based at least in part on the presence or absence of voids. The system may include a downstream production response component configured to receive and respond to the feedback signal. The system may also include a spray system having one or more of the tracking component and the reception component. The spray system may be configured to receive and respond to the feedback signal.

These and other advantages and novel features of the present invention, as well as details of illustrated embodiments thereof, will be more fully understood from the following description and drawings.

### BRIEF DESCRIPTION OF THE DRAWINGS

FIG. 1 illustrates an example embodiment of an imaging system to detect partial spray defects in cans;

FIG. 2 illustrates an example embodiment of logic components associated with the detection of partial spray defects in cans;

FIG. 3 illustrates an example embodiment of a partial spray defect detection system in a production line;

FIG. 4 illustrates an example embodiment of the imaging system of FIG. 1 used in imaging containers for partial spray defects;

FIG. 5 illustrates an example embodiment of a methodology for analyzing container images;

FIG. 6 illustrates an example embodiment of a methodology for developing a template image used in partial spray detection;

FIG. 7 illustrates an example embodiment of a methodology for analyzing container images with a strobed illuminator;

FIG. 8 illustrates an example embodiment of a methodology for determining coating characteristics of a coated container; and

FIGS. 9A, 9B, and 9C illustrate example embodiments of images used in template matching for purposes of finding inconsistencies in a container coating.

### DETAILED DESCRIPTION

Embodiments of the systems and methods described herein provide for the detection and/or identification of partial spray defects and other container coating inconsistencies before filling and/or sealing of the container (e.g., a beverage can). In at least one embodiment, an image is captured of the inside of a coated can, and the captured image is analyzed to identify characteristics (e.g., consistency, adhesion, thickness, coating voids) of the coating inside the can.

In specific embodiments, beverage cans in-process are illuminated and imaged as they move through a production line after a layer of coating is applied to an inside of the cans. Imaging can be performed with a video camera while illumination occurs using a light source. In some embodiments, the video camera is a monochrome video camera using a wide-angle lens. The light source can be strobed as cans move through the process. The illumination source may comprise one or more ultraviolet (UV) light emitting diodes (LEDs). In some embodiments, other spectrums of light are emitted by one or more diodes. Characteristics or settings of both camera(s) and LED(s) can be selected or tailored to maximize contrast between surfaces exhibiting different coating characteristics (e.g., coated versus uncoated, lightly coated versus heavily coated) in captured images.

In alternative embodiments, a still camera or other imaging device (e.g., thermal optic, image intensifier) can be employed, and are coordinated with or timed to the illumination source. One or more images of at least coated portions of a can are captured and stored. Color images may also be employed in embodiments where image processing algorithms are adapted for such (e.g., color analyzed for measuring coating thickness).

The captured images are transmitted to various logic components which perform analysis on the images. For example, edge-finding algorithms are employed to identify the locus of the upper edge of the can, and the center of the can's image is calculated from this locus. In alternative or complementary embodiments, other features, such as the bottom of the can, are identified using machine vision techniques. Once the position of the center is known, this position is used to precisely align the inspection process with the image of the can (e.g., align a template image with an acquired image of the can). In some embodiments, the can image is scaled to precisely size the image to a stored or trained template for the particular production. Ratio analyses may also be performed, and images adjusted accordingly, to ensure no distortion of the images interferes with template matching or other techniques. Various locator, aligner, and comparator tools can be employed to perform these or other aspects.

As suggested, template matching can be used on a captured image (or “suspect”) for purposes of analyzing the captured image. In such embodiments, a template or reference image is established through processing of known good samples (e.g., fully-coated cans). An image subtraction is then performed whereby the suspect is subtracted from the template. Regions can be quantified, and regions having results with absolute values above a preset threshold may be identified as coating voids or other defects.

The template need not be a single image, but can be a statistically trained set of images including a large number of known-good samples. Thus, suspects can be compared to one or more statistical models, rather than a single fixed template. Further, the statistical models may be adjusted over time (e.g., for changing ambient light or transparency where the imaging does not occur in a light-controlled environment) to facilitate flexible application of the detection technique.

As discussed, various edge- and center-finding techniques are employed to facilitate alignment of the suspect and the template images. In some embodiments, a series of video frames can be of degraded quality (e.g., blurred) or a still camera image can be mis-timed, resulting in a suspect providing only a partial exposure of the container (e.g., only partially visible). In such embodiments, the partial exposure may be analyzed in the same fashion, or the container may be flagged as requiring repeat analysis or discarded as flawed. In some embodiments, if a preset threshold of partial exposures occurs consecutively (e.g., 2 or more) or in a batch (4 of any 10), an alarm may be generated, or production may be halted, to provide an opportunity to diagnose and reconcile issues with timing or other functions.

One or more enclosures are provided to isolate the imaging and illumination components from debris or contamination, while allowing the imaging and illumination components to communicate optically with image suspects through a transparent window. For example, where imaging occurs near a coating process, mist or spatter from the coating may contaminate imaging components. Thus, an enclosure may be provided to avoid corruption of images. In some embodiments, image processing algorithms are employed to identify dirtying of the enclosure and compensate for mist, film, or spatter that accumulates on the enclosure. In this way, quality analysis may continue without requiring immediate cleaning or replacing of the enclosure. Large-spatter contamination (e.g., a blob of coating blocking a portion of a lens) and finer accumulation (e.g., a clear portion of the enclosure shielding a camera or illumination sources gradually transmitting lower percentages of light there through) may be adjusted for in this manner (e.g., discarding a portion of the captured image, darkening or lightening the template image). Adjustments can be accomplished through hardware implementation (e.g., adjusting a voltage or a current of the illumination source), software implementation (e.g., multiplying the pixel values in an image by a scaling factor to adjust for brightness), or combinations thereof. In specific embodiments, a control signal to generate an alarm or halt production may be provided if disruption from contamination to the enclosure exceeds a threshold (e.g., spatter blocks more than five percent of the view, accumulated film reduces light transmission by more than ten percent).

The transparent window is designed (e.g., geometries, materials) and/or treated to minimize reflection and maximize transmission of the relevant wavelength spectrums through its transparent material (e.g., glass, polymer, mineral). The lens of the camera and illuminator may be placed very close to or in contact with the window to further reduce reflection or distortion. Antireflective coatings may be applied to one or both sides of the window and/or other components, and a mechanical light baffle can surround at least the barrel of the camera lens and extend to the window. The transparent window of the enclosure can be periodically cleaned or replaced as it becomes dirty by way of its proximity to a coating process or through routine use.

In some embodiments, at least the imaging and illumination components are located at or immediately after components dedicated to applying the coating to the inside of the beverage can. However, while imaging herein is generally described as occurring between a coating process and subsequent steps (e.g., before the coating dries), it is understood that this or other similar inspections may be performed at other locations or times within a production or process sequence. For example, even after a coating has dried, imaging and analysis of the coating quality or characteristics may be performed. In some embodiments, two or more coats are applied, and analyses are performed after each coat, or after all coats are complete. One or more coats may be wet, or all may be dry in such instances. Various alternatives related to illumination (e.g., wavelength of strobe), coating color (natural or colorant-added) and other variables may be utilized to perform analysis in various steps.

In some embodiments, imaging occurs while containers are moving through a trackwork or tunnel (e.g., tumbling, rolling, sliding) in a manner lacking positive control of the container in terms of all dimensions of translation or rotation. In such embodiments, one or more cameras may be provided at various points to provide one or more images of the container, facilitating repeatable analysis of subsequent suspects. Multiple cameras can be employed to provide a plurality of angles to maximize the incidence of images for use in template (or partial-template) matching (or other image processing techniques). Where positive control is not maintained over each container proceeding through a production line, a part tracking apparatus (e.g., through-beam photoelectric sensor, metal proximity detector, scales, and others) can be used to determine and distinguish the movement of individual parts.

Further, while coating processes discussed herein are described in terms of a coating sprayed to one side or inside of a container, those skilled in the art will appreciate how the disclosures herein can be adapted to function with coatings applied using other means or to other portions of containers or other materials. For example, coating or coloration to the outside of a container can be imaged and analyzed, voids can be identified in the coating of a two-dimensional sheet, and so forth.

Containers identified as possessing coating void (e.g., partial spray) defects are rejected individually or used to trigger notifications related to the coating process allowing for modifications avoiding future defects. In some embodiments, a feedback signal is propagated to another component (e.g., response component, removal component) that removes one or more cans having coating void defects from a production line.

While the drawings show particular components as distinct from one another, it is appreciated that components can be combined, or additional components defined, without departing from the scope or spirit of the innovation. For example, an imaging component and logic component can be combined into a single component, or combined apparatus, under the disclosures herein. The term “component” as used herein may refer to a hardware component, a firmware component, a software component, or some combination thereof. For example, the term “void detection component” may refer to software instructions stored in computer memory that are executable on a hardware processor.

“Software” or “computer program” as used herein includes, but is not limited to, one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, an application, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Computer” or “processing device” or “computing device” or “processor” as used herein includes, but is not limited to, any programmed or programmable device that can store, retrieve, and process data. “Non-transitory computer-readable media” include, but are not limited to, a CD-ROM, a removable flash memory card, a hard disk drive, a magnetic tape, and a floppy disk. “Computer memory”, as used herein, refers to a storage device configured to store digital data or information which can be retrieved by a computer or processing element. The terms “controller” or “control system” or “control device” are used broadly herein and may be anything from a simple switching device, to one or more processors running computer-executable software instructions, to complex programmable and/or non-programmable logic circuitry. The terms “signal”, “data”, and “information” may be used interchangeably herein and may be in digital or analog form. The term “functionality” as used herein may refer to the logical actions and/or the supporting display screens of a system implemented in software and/or hardware.

As used herein, a coating, a surface coating treatment, a spray coating, or similar language are used to indicate a material applied to a bare surface (e.g., metal of a beverage can) that attaches or bonds to, reacts with, or otherwise adds to or modifies the surface of the material. For example, in beverage cans, coatings can prevent the beverage from contacting the metal of the can, providing an intermediate layer that will not leak or fail, or cause contamination or spoilage of the beverage.

While aspects herein frequently refer to detection of partial spray or void defects in a coating, process monitoring and feedback relating to the thickness, composition, and other characteristics of one or more coating layers can be assessed and actioned. Such characteristics can be statistically tracked to define templates for optimization of specific parameters for one or more end-products (e.g., filled and sealed containers). In some embodiments, imaging systems are employed during a spray process to facilitate operator viewing of or automated feedback to a coating process before coating is complete.

As indicated above, a coating characteristic, characteristic, or similar language is used to indicate a particular character or quality of a coating instance. For example, for an analyzed coating, the specific instance may have a coating of a particular thickness, consistency, pattern, et cetera. Further, coatings may have defects (e.g., incomplete coating including voids, uneven coating thickness, coating portions that fail to adhere to the coated surface, and others) which are also characteristics of the coating being analyzed.

Still further, while coatings herein generally relate to wet-application coatings (e.g., liquid or gel applied which later dries), it is understood that imaging techniques as described herein can be used in conjunction with dry-application (e.g., powders, tape-like products, and others) without departing from the scope or spirit of the innovation.

In addition, while aspects herein may refer to the use of template matching for purposes of identifying voids or other coating characteristics, it will be appreciated upon review of these disclosures that other techniques can be employed to enable similar identification or analysis. For example, edge-finding, blob-finding, symmetry analysis, pixel counting, segmentation, brightness or color analysis, and other techniques can be used, independently or in combination with one another, to determine the presence or absence of specific coating characteristics. Unless specifically indicated otherwise, nothing herein should be read to limit void or characteristic identification to a single technique such as template matching alone.

To such ends, as used herein, a “void detection process” (or operation) is one or more image processing techniques used to detect voids in a coating. Likewise, “characteristic detection process” and “coating characteristic detection process” (or operation) refer to one or more image processing techniques for identifying a characteristic.

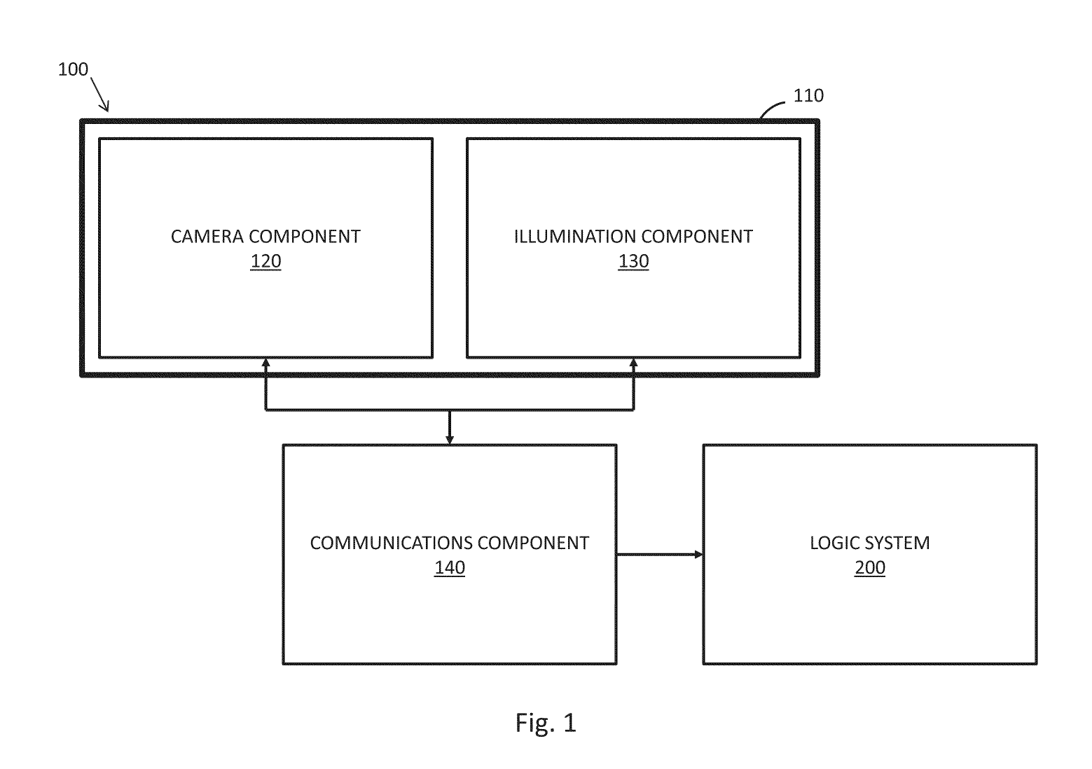

With specific reference to the drawings, FIG. 1 illustrates an example embodiment of an imaging system 100 to detect partial spray defects in cans. The imaging system 100 includes a camera component 120 and an illumination component 130 (contained in one or more enclosure components 110), and a communications component 140. At least the camera component 120 transmits information to the communications component 140. The camera component 120 can further receive information from the communications component 140 or another component (e.g., a motion tracking component, not pictured in FIG. 1). In some embodiments, the illumination component 130 is additionally operatively coupled with (e.g., capable of at least one of receiving data from or transmitting data to) the communications component 140 or another component.

The camera component 120 includes at least one camera configured to capture one or more images of a container in-process after at least one coating process is completed. In some embodiments, the camera component 120 is a monochrome video camera with a wide angle lens mounted at close proximity to the top of coated containers passing through the system. The lens is selected with a specific focal length depending on the camera's placement with respect to passing containers. In some embodiments, the focal length is between 1 mm and 4 mm. A light baffle can be employed about the barrel of the camera lens, or in other positions, to prevent reflected light from interfering with the camera lens. In some embodiments, different types of cameras or multiple cameras (of the same or different types) can be employed. The camera component 120 can be an image recording component, and there can be one or more additional image recording components.

The illumination component 130 includes at least one light source for providing consistent illumination to the coated portion of the container during imaging. In some embodiments, the illumination component 130 is a plurality of LEDs. The LEDs can be arranged in a ring configuration with a center or axis coincident with an optical axis of at least one camera of the camera component 120, with light emitted toward the container to be imaged. The LEDs can have a comparatively small emission angle, resulting in a beam-like light emission. For example, 40-degree full-width emission angle LEDs can be used. Similar to the camera lens of the camera component 120, the light-emitting portions of the illumination component 130 are mounted very close to the top of the container to be illuminated for imaging, allowing the light an uninterrupted path to travel into the container despite the small gap between the container and the camera lens.

The illumination component 130 is configured to provide specific spectrums of light. For example, ultraviolet light can be used to provide a particular degree of contrast between coated and uncoated portions of a container in a captured image. Accordingly, LEDs may be configured to emit light with a wavelength of 375 nm in such examples. Other spectrums or specific wavelengths can also be provided. In some embodiments, multiple LEDs are provided to emit multiple wavelengths, or specific illumination sources can provide more than one wavelength from a single source at different times or simultaneously. Where a specific wavelength or spectrum of light is employed, other portions of at least the imaging system 100 are tuned to the same.

The enclosure component 110 is employed to isolate at least the camera component 120 and the illumination component 130 from contamination from loose coating (e.g., mist, spatter), dust or other production line debris, and other sources capable of interrupting imaging operations. Further, the enclosure component 110 prevents damage to at least the camera component 120, the illumination component 130, and/or other components (e.g., the logic system 200) housed therein.

The enclosure component 110 includes at least a transparent window permitting the camera component 120 to clearly capture images of containers. The transparent window also permits the illumination component 130 to provide light through the enclosure to illuminate coated portions of the container. The window of the enclosure component 110 is designed around a specific wavelength of light emitted by the illumination component 130. The window may be coated with an antireflective coating on one or more sides. In some embodiments, the antireflective coating is also tuned to the particular wavelength(s) of light emitted by the illumination component 130. Additional light baffles or other elements for managing reflection, glare, or other undesirable optical interference can be incorporated in or around the window of the enclosure component 110.

The enclosure component 110 can be sealed hermetically using various construction techniques and seals. In such instances, the enclosure component 110 is sealed in a clean and/or low-humidity environment to reduce contamination or fogging in the enclosure during varying external environmental conditions. In some embodiments, the enclosure component 110 can include dehumidifying (e.g., active such as a powered dehumidifying device, passive such as replaceable desiccant packages) or other components for managing the environment within the sealed enclosure component 110. Alternatively, the enclosure component 110 need not be sealed from the external environment, but only provides a wall on one or more sides isolating another component (e.g., the camera component 120, the illumination component 130) from moving containers or other potentially contaminating or damaging contact.

In some embodiments, the enclosure component 110 facilitates installation of at least the camera component 120 and the illumination component 130 in a “spray box” (e.g., a portion of production dedicated to the application of a coating that is isolated from the rest of the line upstream and downstream to prevent the sprayed coating from escaping). In this way, the footprint of the quality control portion can be reduced or incorporated entirely in the existing production footprint, and various sources of noise (e.g., exterior contamination after exiting the spraying portion, movement of still-wet spray before drying, ambient light outside of the spray box) is reduced. In alternative or complementary embodiments, the enclosure component 110 is thermally insulating to allow installation of at least the camera component 120 and the illumination component 130 in or near a drying component that dries a wet coating.

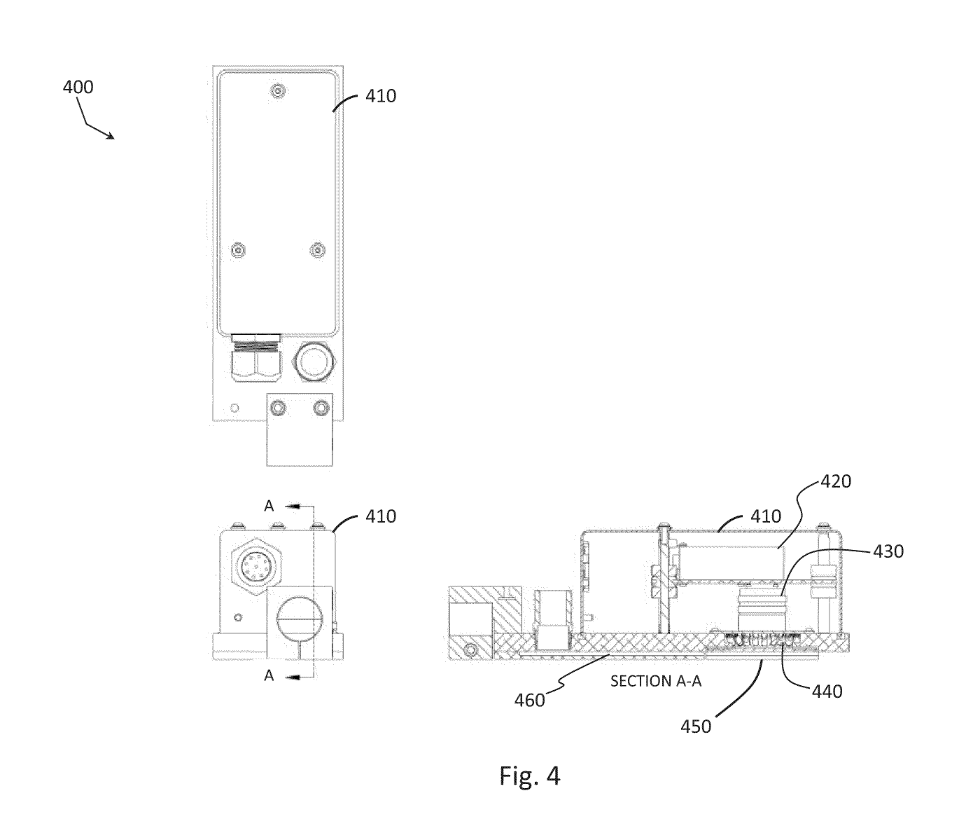

In some embodiments, environmental controls alternative to the enclosure component 110 can be employed. For example, various suction or blower components such as, for example, an air knife component 460 (see FIG. 4) can be employed to mitigate potential contamination near or around the cameras or the light sources.

The communications component 140 provides means for transferring information between at least the various components of the imaging system 100 and the logic system 200. The communications component 140 at least transfers image information as captured by the camera component 120, and can provide control signals to one or more components of the imaging system 100. For example, the communications component 140 can coordinate timing of image capture by the camera component 120 and illumination (e.g., strobing, semi-automatic flash, continuous illumination) by the illumination component 130. In some embodiments, the control signals to the imaging system 100 may originate in the logic system 200. In addition, the communications component 140 can provide at least image data to the logic system 200 for analysis. The communications component 140 can utilize one or more wired and/or wireless standards for data transfer, including various bus interfaces (e.g., Serial AT Attachment, Universal Serial Bus), wired and wireless infrastructure and ad hoc networks (including personal area networks), and other standard or proprietary techniques (e.g., Bluetooth®, infrared) for transferring information between electrical or electronic components.

As or after images are captured, the images can be provided to the logic system 200 to perform analysis that at least detects partial spray defects or other coating characteristics.

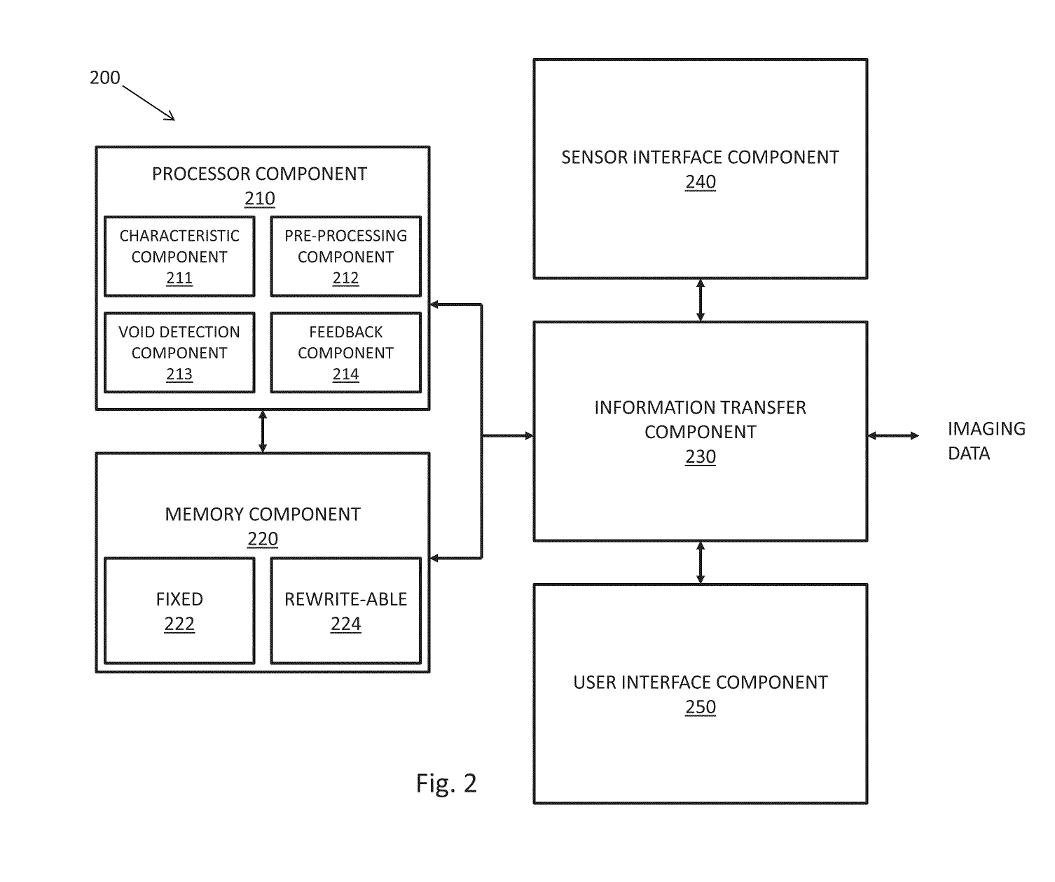

FIG. 2 illustrates an example embodiment of the logic system 200 associated with the detection of partial spray defects in cans. The logic system 200 includes a information transfer component 230, which receives information from at least the imaging system 100 in the form of imaging data. The information transfer component 230 also includes one or more communication means for facilitating communication between components of the logic system 200. For example, the information transfer component 230 facilitates transmission and reception of signals between a processor component 210 and a memory component 220 (e.g., as a bus), or transmission and reception of signals between the logic system 200 and an external user device via a user interface component 250. The processor component 210 may have one or more microprocessors, in accordance with an embodiment.

A sensor interface component 240 is provided to receive sensor data (e.g., from cameras or other sensor inputs) and manage, provide, interpret, or convert sensor data for use by other components. In some embodiments, the sensor interface component 240 includes software or hardware designed to facilitate communication between a particular camera or illumination source of the imaging system 100 and components of the logic system 200. In this way, images from the imaging system 100 are provided to the logic system 200 in a usable format for later analysis. In alternative embodiments, the imaging system 100 provides images in a format compatible with the logic system 200 without further action.

The processor component 210 and the memory component 220 operate in conjunction to store executable code and associated information (e.g., templates, images, statistics, controls, interfaces, algorithms) for performing analysis. The memory component 220 includes a fixed memory 222 and a rewritable memory 224. The fixed memory portion 222 includes firmware or portions of programs used in analyzing coated containers that are permanent or changed infrequently. For example, core image processing functions—such as receiving and analyzing images, developing a template image based on a known-good set, developing “bad” templates based on known-defective sets, and comparison algorithms can be stored in the fixed memory. Particular routines and developed templates can be stored in the rewritable memory. Alternatively, all image processing information may be stored in the rewritable memory, and only basic firmware interfaces are provided in the fixed memory.

Various algorithms, executable codes, and/or routines are stored on or in the memory component 220. In some embodiments, one or more of the sensor interface component 240, the information transfer component 230, the user interface component 250, or portions thereof, are stored using the memory component 220. In some embodiments, components not pictured, such as image preparation components (e.g., optimize or filter received image), template matching components (e.g., image subtraction from template or reference image), other image processing components (e.g., edge-finding, center-finding), feedback and control components (e.g., for modifying system function or generating notifications based on image processing), and others are stored using the memory component 220. One or more of these components (e.g., a template matching component) generates one or more results (e.g., matching and non-matching portions of a suspect in reference to a template) for storage or reuse.

The stored information is executed or processed using the processor component 210. The processor component 210 includes one or more processors in one or more locations operatively coupled with at least one component of the logic system 200 and/or other aspects herein.

Image processing is conducted at least in part using the processor component 210. Results from a template matching component or other aspects are processed and provided to other components. For example, a characteristic component 211 can associate particular coating characteristics with values determined during a template matching process.

In an example of how the processor component 210 and the memory component 220 work, the imaging system 100 provides an image suspect of a coated container via the information transfer component 230. The image suspect may be managed by the sensor interface component 240, which modifies, appends, redacts, packages, or associates the image as needed for storage, identification or tracking (e.g., of the original image and associated container, for version control as the images are modified or utilized), or processing.

In specific embodiments, various pre-processing aspects are completed, such as the applications of various filters, adjustments, transformations, or other modifications to improve edge-finding, contrast, and other steps associated with determining coating characteristics. For example, various blurring or sharpening filters can be utilized to facilitate alignment or a desired resolution. In some embodiments, one or more pre-processing components 212 perform at least a portion of pre-processing. One or more pre-processing components are stored at least in part on the memory component 220 and/or executed using the processor component 210. In alternative embodiments, no pre-processing steps are performed prior to identifying coating characteristics.

The logic system 200 determines coating characteristics including the identification of coating voids or partial spray defects, for example, using a void detection component 213. The void detection component 213 is configured to perform a void detection operation on one or more recorded (acquired) images of the interior of a beverage can, in accordance with an embodiment. The void detection operation may be configured to identify the presence or absence of voids in the sprayed coating on the interior of a beverage can.

Various image processing techniques can be employed to identify and determine the location of voids. For example, edge finding, blob detection, symmetry or asymmetry analysis, classification, and other feature detection algorithms or techniques can be employed to identify possible voids. In some embodiments, two or more techniques are used to identify possible voids, calculate coating thickness, or determine other coating characteristics. By utilizing two or more tests, the results of tests may be strengthened or corroborated to determine improperly coated containers for removal or provide specific feedback for process control.

In specific embodiments, a template matching technique detects or identifies coating characteristics or defects. Before a template matching process occurs on a suspect in production, one or more templates or reference data sets are modeled based on processing and analysis of a set of containers to identify a statistical range of data at least representing a group of containers sharing a specific nature of coating characteristics (e.g., for a specific container and type of coating, containers with or without voids, containers with a specific coating thickness, containers with a specific number of coats, and so forth). The template(s) or reference(s) are then used for comparison (e.g., by image subtraction) to identify characteristics of the suspect.

In some embodiments, a template or reference is developed on-the-fly during production. For example, containers showing asymmetrical coating or portions sharing qualities with uncoated container material (e.g., bare metal) can be identified as possibly defective, whereas containers showing symmetrical coating with image qualities different from those of uncoated container material can be identified as appropriate for forwarding through production. As the sample set grows, the template may be built or refined. Thus, a template can be established during production where none previously existed, or a template can be modified or refined where one previously existed.

Similarly, a different template (e.g., for different coating material or container type) can be adapted to additional product analyses based on updates. For example, a larger container can be scaled to a smaller container size (or suspects can be scaled to the stored template size) to relate desirable or undesirable qualities.

Once a template statistically representative of particular qualities is provided, suspect images captured (e.g., by imaging system 100) are compared to the template. In accordance with one embodiment, a captured image is first processed by way of an edge-finding algorithm to determine the locus of one or more edges of the inside surface of the container (e.g., an “upper edge”). In alternative embodiments, a different visual aspect (e.g., semicircular segment of the bottom of the container) is identified. Using the edges and known geometry, or through other machine vision techniques, the center of the container is found, which is used alone or in combination with the edges to spatially align and identify portions of the captured image for analysis. In alternative embodiments, other portions (e.g., diameters, corners, or other points) are used for identification and alignment.

In some embodiments, an image subtraction is performed (e.g., subtract captured image from image template), and areas having the highest absolute values are identified. If the absolute values of these areas exceed specific thresholds, or if these areas associate with undesirable qualities, the areas are identified as defective. Other techniques (e.g., bright spot detection) can be used alone or in combination with image subtraction or other aspects directed to template matching.

In some embodiments, one or more coating characteristic components performs at least a portion of image processing aspects related to the identification of coating characteristics. One or more coating characteristic components are stored at least in part on the memory component 220 and/or executed using the processor component 210. In some embodiments, fault-finder or flaw-finder components (not pictured) can be included to identify specific defects in a coating. For example, fault-finder components can identify brightness thresholds or regions of interest of predetermined size, location, or shape to associate such anomalies with specific coating faults.

In addition, image processing steps can identify system errors or required maintenance. For example, as contaminants build up on a window of the enclosure component 110, the quality of captured images becomes degraded. Thus, during pre-processing or processing, sudden or gradual systemic changes can be identified for treatment (e.g., notification to operator or maintenance personnel, compensation of the changes via digital processing). For example, a response signal generated by the logic system 200 may be communicated to a service notification device (e.g., a maintenance person's cell phone).

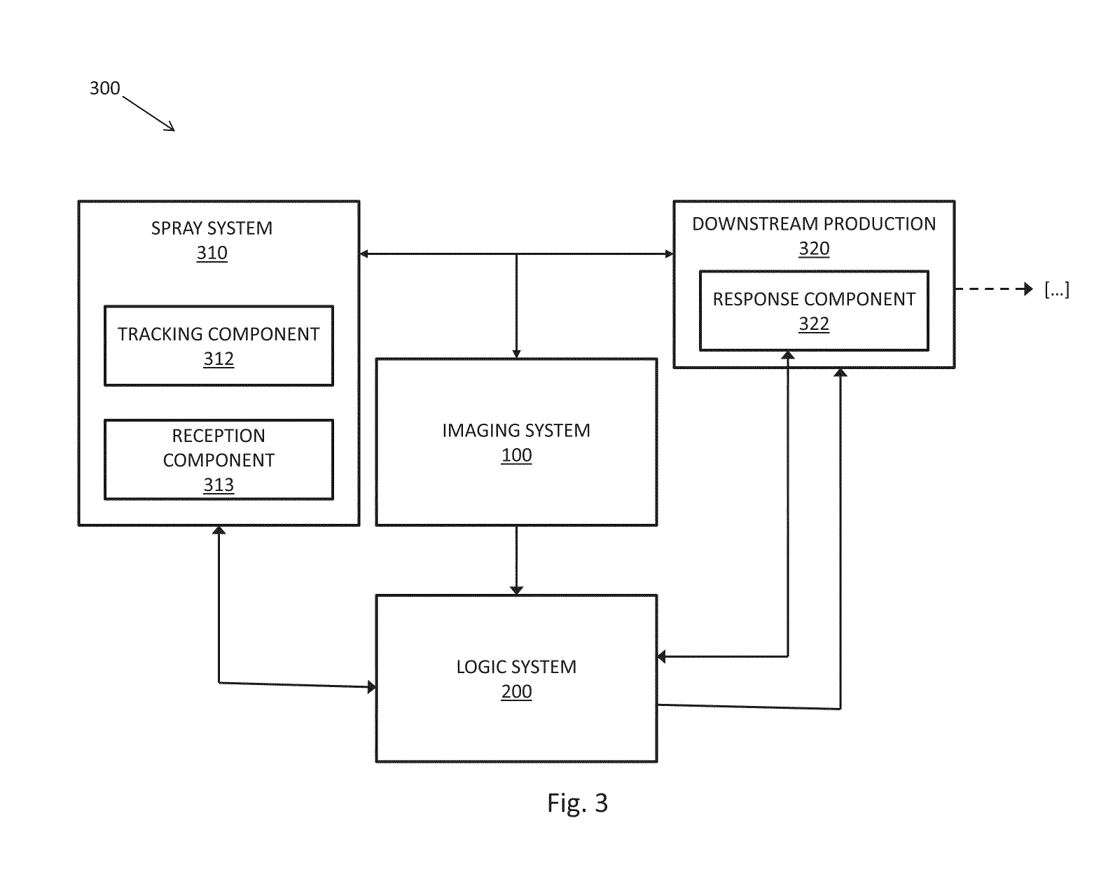

Based on the result of image processing and the identification of particular coating characteristics (e.g., the presence or absence of voids), the logic system 200 generates and transmits various response signals. In some embodiments, a feedback component 214 is used to generate the response signals. For example, after identifying one or more suspects as possessing void defects, a signal is transmitted to a downstream component (e.g., response component 322 of FIG. 3) to remove one or more defective containers. Where particular ratios, thresholds, or percentages of defects or other undesirable characteristics are identified in a group, production can be paused and/or notifications can be generated. Further, service notifications can be generated based on the condition of the imaging system 100, the logic system 200, and/or other components. Therefore, in accordance with certain embodiments, a response signal may be, for example, a service notification signal that is sent to a service notification device (e.g., a maintenance person's cell phone), a production pause signal that is sent to a production pausing device (e.g., a line controller), or a remove container signal that is sent to a container removing device (e.g., a line ejector).

Response signals can be provided to provide automatic control of components operatively coupled with the logic system 200 (e.g., adjustments to the imaging system 100 such as changing the voltage, current, duration, or timing of the illumination component 130) or to provide information to a party. For example, the user interface component 250 may be leveraged to display one or more notifications based on a response signal generated by the logic system 200 using a local or remote user interface. Further, other devices (e.g., computers, personal digital assistants, mobile telephones, industrial controllers, visual or audible alarms) can receive information or be triggered based on the response signals from the logic system 200.

Information received from the imaging system 100 or other sources may be stored in at least the rewriteable memory 224. Further, information developed or modified by the logic system 200 can be stored in the rewriteable memory 224. For example, an original image received from the imaging system 100 may be stored in the rewriteable memory 224, and a copy made in the rewriteable memory 224 may be saved in a copied or modified state after pre-processing. A copy can also be made of a pre-processed image for purposes of image subtraction or other processing steps, with one or more results saved as new files. Results of analysis can be stored individually or in collective databases, and statistical information (e.g., defect rates and associated system settings) can be calculated and stored. Such information can be transferred or exported at least in part using the information transfer component 230.

FIG. 3 illustrates an example embodiment of a partial spray defect detection system in a production line 300. As used herein, “upstream” or “downstream” are used to indicate points earlier or later, respectively, in production. For example, a piece of metal in a coil is upstream from a blank formed from the coil. A coated container is downstream from a container that has not yet been coated in the same production line.

As shown, one or more coating components 310 are integrated in a line with the imaging system 100 and the logic system 200. The coating components 310 apply at least a portion of a coating to a container (e.g., spray to an inside of a can). A tracking component 312 can be associated with the coating components 310 to identify and/or track individual containers through production, allowing individual cans to be followed and actioned based on image processing results based on images of the cans (e.g., based on the presence or absence of voids). For example, defective containers (e.g., improper coating thickness, partial spray) are identified downstream for removal or remediation. Additional components may be utilized to facilitate this process as well. For example, a reception component 313 manages positioning of the containers to ensure proper imaging occurs.

In accordance with an embodiment, the coating components 310 communicate with the imaging system 100 and the logic system 200 to coordinate monitoring or sampling of coating characteristics in production. For example, when the coating components 310 are actuated, the imaging system 100 and the logic system 200 are enabled, and when the coating components 310 are disabled, the imaging system 100 and the logic system 200 are suspended or powered down. In this way, the imaging system 100 and the logic system 200 are utilized efficiently. Further, aspects of timing and calibration can be addressed using information received from the coating components 310.

In some embodiments, the imaging system 100 and the logic system 200 can further transmit information to the coating components 310. For example, control signals can be transmitted to the coating components 310 from one or more of the imaging system 100 and the logic system 200 to pause upstream production (e.g., halt coating components 310) on occurrence of specific conditions such as a defect rate being above a specific threshold, maintenance to the imaging system 100, disconnection of the logic system 200, and others.

The production line 300 includes downstream production 320, which may include aspects such as drying, additional coating, additional forming or annealing, application of other container portions (e.g., lid, opener, decal), filling, sealing, and so forth. Downstream of the point where the logic system 200 completes analysis of an image suspect associated with a particular container, the container passes at least one response component 322. The response component 322 actions a particular container based on analysis by the logic system 200. For example, a particular container may be removed from production after defects are found. Alternatively, a container can be flagged for manual action or rerouted for remediation. Other actions can be taken based on other identified characteristics of the coating.

FIG. 4 illustrates an example embodiment (a component 400) of the imaging system 100 used in imaging containers for partial spray defects. The component 400 is shown in three schematic views, including a top view and a cutaway section view. The component 400 includes at least a cover 410, a camera 420, a lens 430, a lighting group 440, and a window 450.

The cover 410 can be constructed of any suitable material, but is generally realized using rigid materials. For example, the cover 410 can be constructed, in whole or in part, of metals, polymers, ceramics, et cetera.

In some embodiments, the camera 420 is a monochrome video camera. However, alternative embodiments are possible utilizing still cameras, color cameras, and different sensors (e.g., thermal imaging, image intensified technologies, imaging using sonic energy, tomographic imaging) to capture images or representations of at least a portion of an object before the camera. In one embodiment, the camera 420 can include multiple imaging systems, or may be used in combination with cameras not pictured.

The lens 430 can be a wide-angle/field-of-view lens attached to the camera 420. The lens 430 can extend to contact, or nearly contact, the window 450. Further, the lens 430 can include one or more baffles to prevent image degradation from unwanted lighting. In addition, one or more portions of the lens 420 can have anti-reflective or anti-glare material applied.

In some embodiments, lighting group 440 is a ring of LEDs around the circumference (or perimeter, in non-circular embodiments) of the lens 430. Other configurations, such as a single light source or multiple light sources in particular locations, can be utilized in alternative embodiments. Where two or more light sources are among the lighting group 440, the two or more light sources can be directed in a symmetrical (e.g., all light sources angled similarly from a common reference, all light sources at a common distance from the center of the object to be illuminated) or asymmetrical (e.g., light sources at different angles or relative locations) manner.

The window 450 permits the lens 430 to image objects outside of the case 410. The window 450 can be made of any suitable transparent material. For example, the window 450 can be formed at least in part of glass, polymers, ceramics, or other materials. In some embodiments, opaque or color-dyed transparent materials can be used. The window 450 can have anti-reflective or anti-glare materials applied.

Various other housing or mounting hardware can be incorporated in or utilized with the component 400. For example, in the embodiment illustrated, the camera 420 is supported by a mounting plate. The mounting plate is clamped in place at two or more locations. Various other connecting or mounting hardware can be included to facilitate deployment of the component 400 to at least one production line.

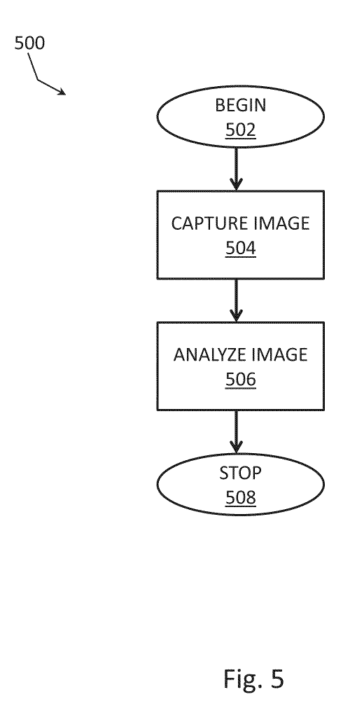

Turning now to FIG. 5, illustrated is an example embodiment of a methodology 500 for analyzing container images. The methodology 500 begins at step 502 and proceeds to step 504 where at least one image is captured of a coated container. At step 506, the image is analyzed in accordance with aspects herein. For example, the image can be processed for development of a template, or matched to (and/or distinguished from) a template to identify characteristics of the image.

In an example of template matching, a suspect image from a container in production can be received at step 504. At step 506, points from the suspect image can be sampled. In some embodiments, the entire suspect image can be analyzed and assessed. The determined point values can be subtracted from the template (or, in some embodiments, vice-versa). Based on the absolute values after image subtraction at step 506, a determination can be made regarding the “match” of the suspect to the template, and defects or deviations can be identified using various ranges of values. In some embodiments, positive and negative values (as opposed to absolute values) are utilized to provide higher resolution data (e.g., where positive values and negative values correlate to different coating characteristics).

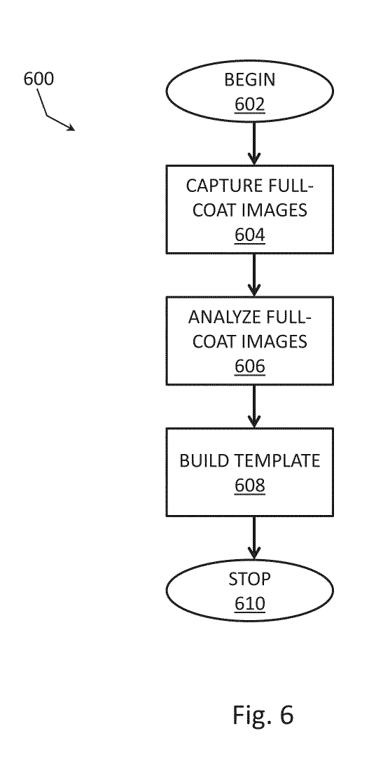

FIG. 6 illustrates an example embodiment of a methodology 600 for developing a template image used in partial spray detection. The methodology 600 begins at step 602 and proceeds to step 604 where “full-coat” (e.g., known-good) images are captured. These images are analyzed at step 606, and a template is built based on the analysis at step 608. At step 610, the methodology 600 stops.

As an example of developing a template, one or more images suitable for use as a template (e.g., known-good samples having identified qualities such as coat thickness or consistency) can be received at step 604. Points (e.g., pixels) can be sampled from the known good images to determine a statistical range of values at the sampled points determined to be good at step 606. By sampling a group, a model can be developed that permits point-to-point matched sampling or interpolation such that samples from a later suspect image can be assessed in view of the template. A model is built, based on particular parameters, or ranges identified representing particular characteristics of the full-coat (or other known characteristics) at step 608. The model and/or ranges by point are then used in image subtraction or other comparisons to determine differences between a suspect and the template.

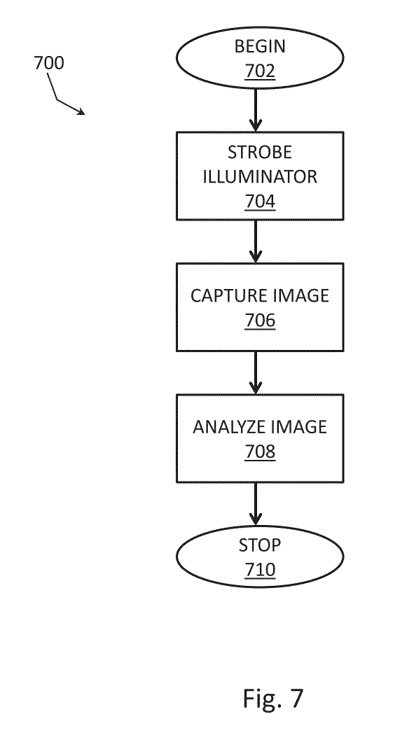

FIG. 7 illustrates an example embodiment of a methodology 700 for analyzing container images with a strobed illuminator. The methodology 700 begins at step 702 and proceeds to strobe an illuminator at step 704. While the target (e.g., container in process) is affected by the illuminator, an image of the target is captured at step 706. This image can be analyzed in step 708 (e.g., template matching performed) to determine characteristics of the target that are present or absent in, or otherwise different from, the template. After the analysis is complete, the methodology 700 can stop at step 710.

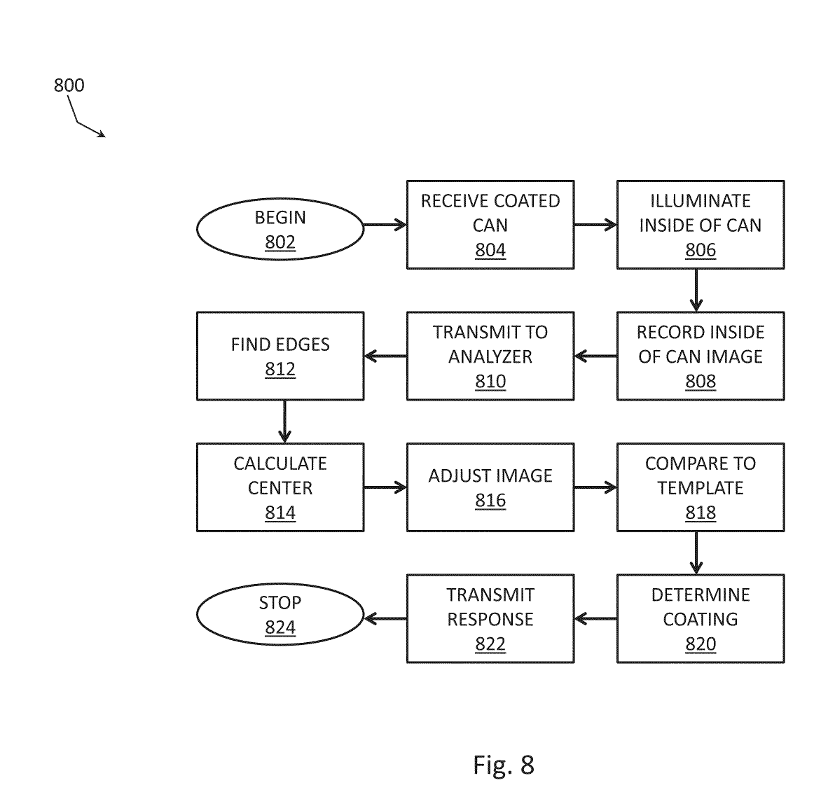

FIG. 8 illustrates an example embodiment of a methodology 800 for determining coating characteristics of a coated container. The methodology 800 begins at step 802 and proceeds to step 804 where a coated can is received on a line. The line can be a production line, an inspection line, or others. The inside of the coated can is illuminated at step 806 to allow for image capture while the can is illuminated.

At step 808, an image of the inside of the coated can is recorded. This image is used as a suspect in template matching to determine whether the can contains defects. This image is transferred to an analyzer at step 810. In some embodiments, the image analysis can be performed locally (e.g., at the image recording component), and step 810 is performed locally (e.g., store to memory and process with local processor).

At step 812, an edge-finding technique can be employed to identify and isolate relevant portions of the image of the can being analyzed. Based on the edge-finding at step 812, a center calculation can be performed at step 814 to identify features of the can and align the can's image with a template. At step 816, final adjustments such as filters or scaling can be performed to more precisely match the captured image to the template.

At step 818, a template matching technique is utilized to identify coating characteristics. In some embodiments, the captured image is subtracted from the template. The image subtraction can rely on sampled points or perform the calculation(s) across the entire image and template. Thereafter, any portions determined to deviate from the template or model by more than a pre-determined threshold (e.g., percentage of value, absolute value, amount for specific area of image) can be identified. Based on these differences, coating characteristics can be determined at step 820. If no identifiable differences exist, or if differences are within acceptable modeled ranges (e.g., differences less than threshold amount), the can is determined to substantially match the template, and share the coating characteristics of the template (e.g., no voids, specific coating thickness, or other characteristics). If differences outside of a specified range exist, other characteristics can be identified (e.g., presence of voids, difference in coating thickness, or other characteristics).

In some embodiments, the causes of coating characteristics can be identified based on statistical models or templates related to particular characteristics. For example, a partial spray template, or deviations to a known-good template, can be used to identify causes of defective coatings such as clogged spray nozzles, damage or inconsistencies to the can, insufficient coating material amounts, and others. Thus, statistical information, feedback signals, or control data can directly address the causes of particular coating characteristics, in addition to tracking the total number of defects or other observed characteristics.

Once coating characteristics are identified at step 820, a response signal can be generated and transmitted at step 822. For example, if no defects are detected, statistical information about the can, and in some embodiments the actual images and data from analysis, can be stored. If defects are detected, a control signal can be transmitted at step 822 to remove or reroute the can to prevent its downstream grouping with acceptable samples. The response at step 822 can also relate to groups of cans or can statistics. In some embodiments, where an unacceptably high defect rate occurs (e.g., more than 10 bad cans in 100), control signals modifying upstream processes, notifications to operators or administrators, pausing of the production line, or other remedial action can be taken via the response at step 822. Upon completion of response(s) (if any), the methodology 800 can proceed to stop at step 824.

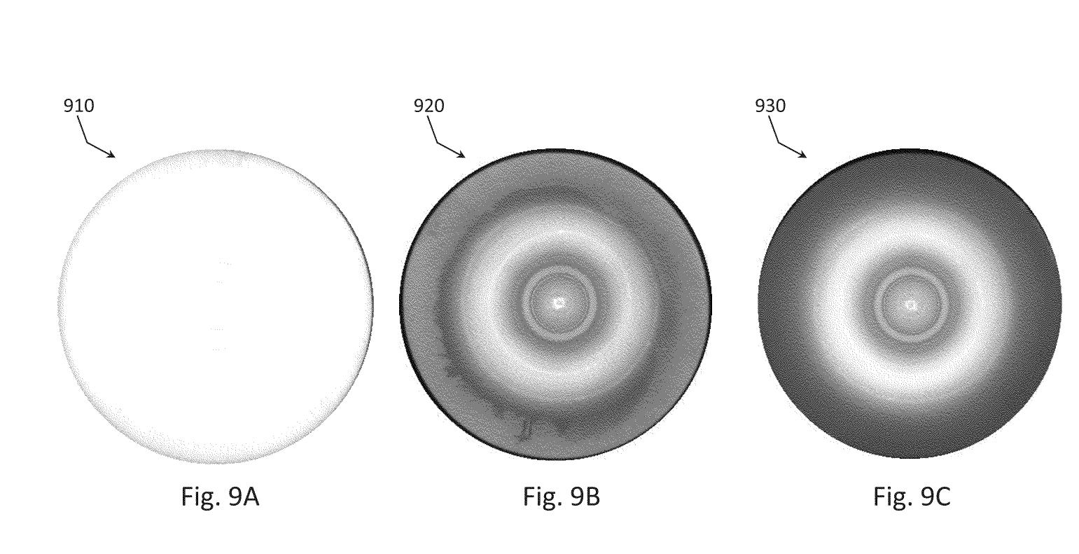

Turning now to FIGS. 9A, 9B, and 9C, illustrated are example embodiments of images used in template matching for purposes of finding inconsistencies in container coating. FIG. 9A shows an image 910 of the inside of a beverage can in an uncoated, “bare metal” state. FIG. 9C shows an image 930 of a properly-coated (“full coat”) can from the inside. The image 910 can be used to identify characteristics of uncoated portions, while the image 930 can be used in development of a template for template matching.

FIG. 9B shows an image 920 of the inside of a recently-sprayed can to be analyzed for defects. As can be seen, the image characteristics (e.g., color saturation, symmetry, size and shape of distinct coated areas) differ from that of both the uncoated can image 910 and the properly-coated can image 930. By performing image subtraction or other image processing steps, the differences between at least the images 920 and 930 can be assessed qualitatively and quantitatively. Based on qualitative and quantitative values associated with particular coating characteristics, in terms of absolute values and differences based on template matching, the coating characteristics present in the image 920 can be determined. Thus, the can associated with the image 920 can be found acceptable or unacceptable and treated accordingly downstream.

In summary, systems and methods to identify defects of a surface coating treatment in a beverage can are provided. One or more image suspects are acquired, including at least a portion of a surface treated by a coating. A coating characteristic detection process is performed on the one or more image suspects. At least one coating characteristic is determined based at least in part on the coating characteristic detection process.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiments disclosed, but that the claimed subject matter will include all embodiments falling within the scope of the appended claims.

What is claimed is:

1. A method to identify characteristics of a surface coating treatment, said method comprising:
acquiring one or more image suspects including at least a portion of a surface treated by a coating;
performing a coating characteristic detection process on the one or more image suspects; and
determining at least one coating characteristic based at least in part on the coating characteristic detection process.

2. The method of claim 1, wherein the coating characteristic detection process includes one or more of edge-finding, blob-finding, symmetry analysis, pixel counting, segmentation, brightness analysis, or color analysis.

3. The method of claim 1, further comprising generating one or more response signals in response to determining at least one coating characteristic.

4. The method of claim 3, further comprising communicating the one or more response signals to one or more of a service notification device, a production pausing device, or a container removing device.

5. The method of claim 1, wherein the at least one coating characteristic includes one or more of a coating void, a coating thickness, an uncoated condition, a lightly coated condition, a heavily coated condition, coating consistency, coating adhesion, and a number of applied coats.

6. The method of claim 1, further comprising illuminating at least the portion of the surface treated by the coating with ultraviolet light.

7. A method to identify characteristics of a surface coating treatment, said method comprising:
acquiring one or more image suspects including at least a portion of a surface treated by a coating;
aligning the one or more image suspects with a template image; and
performing a template matching operation on the one or more image suspects using the template image.

8. The method of claim 7, further comprising identifying one or more coating characteristics based at least in part on a result of the template matching operation.

9. The method of claim 8, wherein the one or more coating characteristics include one or more of a coating void, a coating thickness, an uncoated condition, a lightly coated condition, a heavily coated condition, coating consistency, coating adhesion, and a number of applied coats.

10. The method of claim 7, further comprising generating at least one response signal based at least in part on a result of the template matching operation.

11. The method of claim 10, wherein the at least one response signal includes one or more of a service notification signal, a production pause signal, or a remove container signal.

12. The method of claim 7, further comprising illuminating at least the portion of the surface treated by the coating with ultraviolet light.

13. A system that detects defects in a sprayed coating applied inside a beverage can, said system comprising:
an illumination component configured to emit and direct light to an inside of the beverage can;
an image recording component configured to capture and record one or more images of the inside of the beverage can; and
a characteristic component configured to perform a coating characteristic detection process on the one or more recorded images.

14. The system of claim 13, further comprising a reception component configured to receive the beverage can in an image capture position.

15. The system of claim 13, further comprising a pre-processing component configured to prepare the one or more recorded images for the coating characteristic detection process.

16. The system of claim 13, wherein the characteristic component includes a void detection component configured to perform a void detection operation on the one or more recorded images.

17. The system of claim 16, wherein the void detection operation is configured to identify the presence or absence of voids in the sprayed coating.

18. The system of claim 17, further comprising a tracking component configured to identify and track individual cans through production, allowing the individual cans to be followed and actioned based at least in part on the presence or absence of voids.

19. The system of claim 17, wherein the void detection operation includes one or more of edge-finding, blob-finding, symmetry analysis, pixel counting, segmentation, brightness analysis, or color analysis.

20. The system of claim 17, further comprising a feedback component configured to generate a feedback signal based at least in part on the presence or absence of voids.

21. The system of claim 20, further comprising a downstream production response component configured to receive and respond to the feedback signal.

22. The system of claim 20, further comprising an upstream spray system configured to receive and respond to the feedback signal.

23. The system of claim 13, further comprising an air knife component configured to mitigate contamination near or around the illumination component and the image recording component.
